(19) United States
(12) Patent Application Publication
(10) Pub. No.: US 2006/0091361 A1
(43) Pub. Date: May 4, 2006

(54) Isothiazolone-containing preservative having enhanced stability

(76) Inventors: Klaus Weber, Hamburg (DE); Wolfgang Beilfuss, Hamburg (DE); Ralf Gradtke, Tornesch (DE)

Correspondence Address: AIR LIQUIDE, 2700 POST OAK BOULEVARD, SUITE 1800, HOUSTON, TX, 77056, US

(21) Appl. No.: 11/265,627

(22) Filed: Nov. 2, 2005

(30) Foreign Application Priority Data
Nov. 2, 2004 (DE) 10 2004 052 878.0

(51) Int. Cl. C09K 15/16

(52) U.S. Cl. 252/405

(57) ABSTRACT

Methods and compositions for preserving articles. A preservation composition is made of isothiazolone and a condensation product which includes glycol, urea, and formaldehyde. The composition does not include 5-chloro-2-methylisothiazolone, 2-mercaptopyridine N-oxide or derivatives thereof.

### CROSS-REFERENCE TO RELATED APPLICATIONS

This application claims the benefit of priority under 35 U.S.C. § 119 (a) and (b) to German Application No. 10 2004 052 878.0, filed Nov. 2, 2004, the entire contents of which are incorporated herein by reference.

### BACKGROUND

The present invention relates to a preservative which comprises an isothiazolone and to the condensation product of a mixture which comprises glycol, urea, and formaldehyde. The invention further relates to the use of the preservative in technical products, to the technical product and to the use of the condensation product for stabilizing isothiazolones. The inventive preservative is free from 5-chloro-2-methylisothiazolone and is free from 2-mercaptopyridine N-oxide and derivatives thereof.

Isothiazolin-3-ones (isothiazolones) are known as active bactericidal and fungicidal compounds, for example, in cooling lubricants for metalworking. However, certain components in metalworking fluids and a high pH have a tendency to destroy the isothiazolones and thus eliminate their microbiological activity. This is the case, in particular when the metalworking fluids are present in concentrated form. Therefore, there has been no lack of attempts to propose stabilizers for isothiazolones.

EP 0 425 143 A, U.S. Pat. No. 4,150,026, and U.S. Pat. No. 4,241,214 disclose that metal salt complexes of isothiazolones can be used owing to their enhanced thermal stability, while the biological activity of the isothiazolones is retained. EP 0 315 464 discloses orthoesters and EP 0 342 852 discloses epoxides as stabilizers.

U.S. Pat. No. 4,129,448 and U.S. Pat. No. 4,165,318 propose to use, as stabilizer for isothiazolones, formaldehyde or a compound which releases formaldehyde under basic conditions. As formaldehyde-releasing compounds, various quaternary ammonium chlorides are proposed. Apart from the fact that these substances are comparatively expensive chemicals, chlorine-containing preservatives are frequently undesirable. Isothiazolone-containing preservative concentrates are not disclosed.

It is further known to use sulphur compounds for stabilizing isothiazolones (EP 0 777 966 A, GB 2 208 474 A, U.S. Pat. No. 5,725,806, GB 2 230 190, and U.S. Pat. No. 5,210,094). DE 195 34 532 A, in addition to a sulphur-containing stabilizer, proposes the use of a solubilizer. EP 0 530 986 A2 proposes stabilizing isothiazolones by adduct formation with nitrogen-containing, sulphur-free compounds, for example, pyridine N-oxide, 2-pyrrolidone, s-triazine or dimethyl oxime.

The stability of isothiazolones in combination with N-formals is also unsatisfactory. For instance storage, transport or use at elevated temperatures lead to the breakdown of isothiazolone and thus to a preservative no longer having sufficient microbicidal activity. Therefore, DE 199 61 621 A1 prescribes the presence of 2-mercaptopyridine N-oxide or salts thereof for stabilizing isothiazolones in the event of an N-formal content.

DE 28 00 766 A discloses a preservative which, in addition to 5-chloro-2-methylisothiazolone, comprises a mixture of 20-30% of dimethylolurea, 50-75% of one or more adducts of 2 mol of formaldehyde and aliphatic glycols having 2-8 carbon atoms and/or monoalkyl ethers of these glycols having 1-6 carbon atoms in the ether radical. These adducts are O-formals, the presence of which, because of elevated formaldehyde emissions and odour nuisances at elevated temperatures, is disadvantageous.

Furthermore, a combination of Kathon 886 (that is to say 5-chloro-2-methylisothiazolone and 2-methylisothiazolone in a ratio of 3:1 in about 14% strength aqueous solution) with the condensation product of glycol, urea, and formaldehyde is known as a commercial product. The combination, however, has very limited stability at elevated temperatures (for example, above 30° C.) and is sensitive to pH effects, and must therefore be stabilized with compounds such as 2,2′-dithiobis(pyridine N-oxide) (Pyrion disulfide).

### SUMMARY

The object underlying the present invention was thus to provide substances which:
stabilize isothiazolones and isothiazolone-containing mixtures during storage, during transport and in use, even at elevated temperatures, without discoloration or odour nuisance occurring,
have advantages with respect to the official labelling regulations,
stabilize isothiazolones even in the form of a concentrate,
support isothiazolones in their microbicidal activity, and
are inexpensive.

It has now surprisingly been found that this object is achieved by the condensation product of a mixture which comprises glycol, urea, and formaldehyde.

The invention thus relates to a preservative which comprises
a) isothiazolone, and
b) the condensation product of a mixture which comprises glycol, urea, and formaldehyde, the preservative being free from 5-chloro-2-methylisothiazolone and free from 2-mercaptopyridine N-oxide and derivatives thereof.

The invention includes both methods and compositions to achieve the desired results, as described, but is not limited to the various embodiments disclosed.

### DESCRIPTION OF PREFERRED EMBODIMENTS

The invention is based, inter alia, on the fact that it has been found that a particularly stable isothiazolone-containing preservative can be obtained, even without addition of 2-mercaptopyridine N-oxide and derivatives thereof (for example, without the sodium salt, Pyrion-Na, and without the dithioether, Pyrion disulfide), if, in combination with the isothiazolone (different from 5-chloro-2-methylisothiazolone), use is made of the condensation product of a mixture which comprises glycol, urea, and formaldehyde.

Isothiazolones used according to the invention are preferably selected from 2-n-octylisothiazolone, for example, the pure active compound (Kathon 893T) or the 45% strength solution in 1,2-propylene glycol (Kathon 893), 2-methylisothiazolone, 4,5-dichloro-2-n-octyliso-thiazolone, 2-n-butylisothiazolone, and benzoisothiazolone, 2-n-octylisothiazolone being particularly preferred.

In a preferred embodiment, the preservative is present as concentrate and then comprises 0.25-5% by weight of isothiazolone, preferably 0.5-3% by weight, for example, 0.7 to 1.4% by weight, for instance 1.1% by weight of isothiazolone.

According to the invention, as stabilizer, use is made of the condensation product of a mixture which comprises glycol, urea, and formaldehyde. It has surprisingly been found that these condensation products yield extraordinarily stable and in particular thermally stable compositions, that is to say concentrates and preserved technical products, having a content of isothiazolone (different from 5-chloro-2-methylisothiazolone). This increase in stability is demonstrated in a particularly noticeable manner in storage under thermal stress, as can occur during transport and storage, or during processing. The advantage is observed, not only in the concentrate, but also in the preserved technical product, with, surprisingly, no presence of 2-mercaptopyridine N-oxide or derivative thereof being necessary for the stabilization.

In a preferred embodiment, the preservative is present as concentrate and then comprises about 99.75-95% by weight of the condensation product, preferably about 99.5-97% by weight, for example, 99.3-98.6% by weight, for instance 98.9% by weight of condensation product.

In a preferred embodiment, the glycol is monoethylene glycol. In a further preferred embodiment, the mixture further comprises a small amount of potassium carbonate. In a particularly preferred embodiment, though the mixture is free from butyl diglycol, such preservatives have a particularly good stability.

In a particularly preferred embodiment, the mixture processed to give the condensation product comprises monoethylene glycol, a small amount of potassium carbonate, urea, and formaldehyde (used as paraformaldehyde). Mixtures are preferred which consist of about 34% by weight of monoethylene glycol, a small amount of potassium carbonate, about 14% by weight of urea, and about 52% by weight of paraformaldehyde (91% strength).

Preferred mixtures comprise glycol, urea, and formaldehyde in the following amounts (% by weight).

| | | | Even More |
|---|---|---|---|
| | Preferred | More Preferred | Preferred |
| Glycol (for example, | 24-44 | 29-39 | 32-36 |
| monoethylene glycol) | | | |
| Urea | 17-32 | 20-28 | 23-25.5 |
| Formaldehyde | 33-60 | 40-55 | 45-50 |

The constituents can be added to the mixture in various ways. In a variant A, a mixture comprising a urea-formaldehyde adduct (for example, dimethylol urea) and the reaction product of glycol and formaldehyde is prepared. In a variant B, a mixture comprising a urea-formaldehyde adduct (for example, dimethylol urea) and an alkylene glycol formal is prepared. In a variant C, a mixture comprising urea, formaldehyde, and the reaction product of glycol with formaldehyde is prepared. In the particularly preferred variant D, a mixture is prepared which comprises formaldehyde, urea, ethylene glycol, and, if appropriate, a small amount of potassium carbonate. In a variant E, a mixture is prepared which comprises the reaction product of formaldehyde with glycol with addition of urea.

After preparation of the mixture, this is processed to give the condensation product. The condensation is performed at a temperature of at least about 40° C., preferably at least about 50° C., more preferably about 70° C. to about 105° C., in particular about 90° C. to about 100° C., a condensation temperature of about 95 to about 100° C. being particularly preferred. After the end of the condensation reaction, preferably no water is taken off. In a preferred embodiment, the condensation of the mixture is performed at about 95° C. for a period of about 3 hours.

In a preferred embodiment, the preservative is present as concentrate and contains no added organic solvent, apart from a small amount of, for example, less than 3% by weight, preferably less than 2% by weight, possibly introduced together with the isothiazolone. Preferred inventive concentrates have a water content of less than 45% by weight, preferably 2 to 30% by weight, more preferably 5 to 15% by weight, for instance 10% by weight.

Inventive preservatives which are present in the form of a concentrate preferably comprise
a) about 0.25-5% by weight, preferably about 0.5-3% by weight, for example, about 1.1% by weight, of isothiazolone, and
b) about 99.75-95% by weight, preferably about 99.5-97% by weight, for example, about 98.9% by weight, of the condensation product.

Concentrates are preferred which essentially consist of these two components, with, if appropriate, a small amount of fragrance being able to be added.

The invention further relates to the use of the inventive composition for preserving technical products, in particular crop protection agents, agents for treating seed material, technical preservatives, in particular container preservatives, cooling lubricants, fuel additives, disinfectants, in particular low-foam disinfectants, agents for controlling incised wounds, parasites, and plants, agents for treating pruning wounds, film preservatives for the outdoor, and in particular the indoor, sector, disinfectants in areas where increased fungal attack is to be expected, agents for preserving concrete additives, technical preservatives for tropical zones and wood preservatives. A preferred amount of the concentrate in the technical products is about 0.01-1% by weight, more preferably about 0.05-0.5% by weight, in particular about 0.1-0.3% by weight, for instance about 0.15% by weight.

The invention further relates to the use of the condensation product of a mixture which comprises glycol, urea, and formaldehyde for stabilizing isothiazolones (different from 5-chloro-2-methylisothiazolone) without addition of 2-mercaptopyridine N-oxide and derivatives thereof.

The advantages of the present invention are demonstrated, in particular, by the examples hereinafter.

### EXAMPLES

The content of 2-n-octylisothiazolone was determined by HPLC, in which each 0.5 g of sample was weighed into a 50 ml measuring flask and made up with 50% strength H₃PO₄ (0.1 strength)/50% acetonitrile. The solution was then injected into the measuring apparatus. As a reference sample, 100 mg of Kathon 893 was weighed into a 100 ml measuring flask and made up with 85% strength H₃PO₄ (0.1% strength)/50% acetonitrile, then injected into the measuring apparatus. The measuring apparatus used was an HPLC combination of a pump (Waters 600), a detector (Waters PDA 996), an injection system (Waters Autosampler WISP 717), a column (Nucleosil 100, C 18.5, 10 μm, 100×4 mm i.d. using the eluent A=H₃PO₄ (0.1% strength (g/g)) and B=acetonitrile. Elution was performed using 90% A/10% B in 10 min to 20% A, 80% B, then in 7 min to 10% A, 90% B, then washing and conditioning the column. Flow rate 1.0 ml/min, wavelength: 273 nm, injection volume 10 μl.

Concentrates were prepared using the following constituents and tested for their storage stability:

| | A | B | C | D | E |
|---|---|---|---|---|---|
| | Invention | Invention | comparison | comparison | comparison |
| OIT | 2.5% | 2.5% | 2.5% | 2.5% | 2.5% |
| Condensation product A | 97.5% | | | | |
| Condensation product B | | 97.5% | | | |
| Methylenebismethyloxazolidine | | | 97.5% | | |
| Trimethyltriazinetri-ethanol | | | | 97.5% | |
| Triazinetriethanol | | | | | 97.5% |
| After mixing | clear | clear | clear | clear | clear |
| | colourless | colorless | colourless | colorless | yellowish |
| | solution | solution | solution | solution | solution |
| Storage at room temperature | 1.17% | 1.15% | 1.18% | 0.07% | 0.12% |
| OIT content after 2 days | | | | | |
| Appearance after 5 days | clear | clear | clear | turbid | turbid |
| | colourless | colorless | colorless | yellow | yellow |
| | solution | solution | solution | liquid | liquid |
| Storage at 40° C., | | | | | |
| OIT content after 1 | 1.16% | 1.19% | 1.19% | <0.01% | <0.01% |
| month | | | | | |
| Appearance after 1 | clear | clear | clear | clear | clear |
| month | colorless | colorless | colorless | orange | dark-yellow |
| | solution | solution | solution | solution | solution |
| Storage at 40° C., | | | | | |
| OIT content after 2 | 1.08% | 1.12% | 1.12% | <0.01% | <0.01% |
| months | | | | | |
| Appearance after 2 | clear | clear | clear | clear | clear |
| months | colorless | colorless | colorless | orange | orange- |
| | | | | | yellow |
| | solution | solution | solution | solution | solution |
| Storage at 40° C., | | | | | |
| OIT content after 3 | 1.09% | 1.14% | 1.13% | <0.01% | <0.01% |
| months | | | | | |
| Appearance after 3 | clear | clear | clear | clear | clear |
| months | colorless | colorless | colorless | orange | orange- |
| | | | | | yellow |
| | solution | solution | solution | solution | solution |
| Storage at 60° C., | | | | | |
| OIT content after 1 | 0.57% | 1.17% | 0.01% | <0.01% | <0.01% |
| month | | | | | |
| Appearance after 1 | clear | clear | clear | clear | clear |
| month | yellow | colorless | yellow | red | red |
| | solution | solution | solution | solution | solution |
| Storage at 60° C., | | | | | |
| OIT content after 2 | <0.01% | 1.08% | <0.01% | <0.01% | <0.01% |
| months | | | | | |
| Appearance after 2 | clear | clear | clear | clear | clear |
| months | yellow | colorless | yellow | red | red |
| | solution | solution | solution | solution | solution |
| Storage at 60° C., | | | | | |
| OIT content after 3 | <0.01% | 1.05% | <0.01% | <0.01% | <0.01% |
| months | | | | | |
| Appearance after 3 | clear | clear | clear | clear | clear |
| months | orange- | colorless | yellow | red | red |
| | yellow | | | | |
| | solution | solution | solution | solution | solution |

These results verify that N-formals cannot stabilize isothiazolones even at room temperature (according to the teaching of DE 199 61 621, the addition of a stabilizer such as Pyrion-sodium is necessary). In contrast, 2-n-octylisothiazolone is made very storage stable by inventive condensation products even under thermal stress, the stabilization using condensation product B (mixture without butyl diglycol) being better than using condensation product A (see the results for storage at 60° C.).

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A composition which may be used as a preservative wherein:
a) said composition comprises:
1) isothiazolone; and
2) a condensation product of a mixture, wherein said mixture comprises:
i) glycol;
ii) urea; and
iii) formaldehyde; and
b) said composition is free from:
1) 5-chloro-2-methylisothiazolone;
2) 2-mercaptopyridine N-oxide; and
3) derivatives thereof.

2. The composition of claim 1, wherein said isothiazolone comprises at least one member selected form the group consisting of:
a) 2-n-octylisothiazolone;
b) 2-methylisothiazolone;
c) benzoisothiazolone;
d) 4,5-dichloro-2-n-octylisothiazolone;
e) 2-n-butylbenzoisothiazolone; and
f) mixtures thereof.

3. The composition of claim 2, wherein said isothiazolone comprises 2-n-octylisothiazolone.

4. The composition of claim 1, wherein said glycol comprises monoethylene glycol.

5. The composition of claim 1, wherein said compound is free from butyl diglycol.

6. The composition of claim 1, comprising:
a) about 0.25% to about 5%, by weight, of isothiazolone; and
b) about 99.75% to about 95%, by weight, of said condensation product.

7. The composition of claim 6, comprising:
a) about 0.5% to about 3%, by weight, of isothiazolone; and
b) about 99.5% to about 97%, by weight, of said condensation product.

8. The composition of claim 7, comprising:
a) about 1.1%, by weight, of isothiazolone; and
b) about 98.9%, by weight, of said condensation product.

9. A composition, which may be used as a preservative, wherein said compound consists essentially of:
a) about 0.5% to about 3%, by weight, of 2-n-octylisothiazolone; and
b) about 99.5% to about 97% of a condensation product mixture, wherein said mixture comprises:
1) monoethylene glycol;
2) potassium carbonate;
3) urea; and
4) paraformaldehyde.

10. A method which may be used to preserve products, said method comprising preserving at least one product by applying a composition to said product, wherein:
a) said composition comprises:
1) isothiazolone; and
2) a condensation product of a mixture, wherein said mixture comprises:
i) glycol;
ii) urea; and
iii) formaldehyde; and
b) said composition is free from:
1) 5-chloro-2-methylisothiazolone;
2) 2-mercaptopyridine N-oxide; and
3) derivatives thereof.

11. The method of claim 10, wherein said composition has a concentration between about 0.01% and about 1%, by weight.

12. A method which may be used to stabilize isothiazolones, said method comprising stabilizing at least one isothiazolone with a condensation product, wherein:
a) said condensation product comprises:
1) glycol;
2) urea; and
3) formaldehyde; and
b) said isothiazolone is not 5-chloro-2-methylisothiazolone.
